(19) United States
(12) Patent Application Publication
(10) Pub. No.: US 2007/0078927 A1
(43) Pub. Date: Apr. 5, 2007

(54) Server-side service framework

(75) Inventors: Ting-hao Yang, Kirkland, WA (US); David Ebbo, Redmond, WA (US); Nikhil Kothari, Sammamish, WA (US); Simon Calvert, Issaquah, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation, Redmond, WA (US)

(21) Appl. No.: 11/318,226

(22) Filed: Dec. 23, 2005

Related U.S. Application Data
(60) Provisional application No. 60/716,055, filed on Sep. 12, 2005.

(51) Int. Cl. G06F 15/16

(52) U.S. Cl. 709/203

(57) ABSTRACT

Supplementing the traditional means of exposing a server service through a URL that maps to a physical file with a special extension containing the service, a pseudo-virtual path mapping directly to the service is provided to clients requesting the service. The pseudo-virtual path includes a special token that identifies a path to be a pseudo-virtual path. Content following the special token maps directly to the service by identifying, for example, type information associated with the service. A pseudo-virtual path may be generated through an application programming interface and may also be encrypted before being passed over to a client.

### CROSS-REFERENCE TO RELATED APPLICATION

This application claims the benefit of U.S. Provisional Patent Application No. 60/716,055, filed Sep. 12, 2005, entitled “SERVER-SIDE SERVICE FRAMEWORK,” the disclosure of which is hereby expressly incorporated by reference, and the filing date of which is hereby claimed under 35 U.S.C.§ 119(e).

### BACKGROUND

In a system including a client component (“client”) and a server component (“server”), the server may want to expose a service that the client can use. Traditionally, to expose a service, a developer writes a special file with a special extension for the service. For example, in the Microsoft .NET™ platform, a Web service is exposed as a result of the existence of an ASMX file on the server; the special extension is ASMX. A Web service generally provides one or more methods existing on the server that allows the client to call to get certain information. A Web service is usually called through the use of a URL. For example, the URL http://www.xyz.com/app/login.asmx leads to a login service on a server for XYZ.com. Typically, the URL points to a physical file, such as an ASMX file existing on the server. The client can call the Web service by using the URL that leads to the ASMX file on the server.

Using traditional methods for exposing a service, a developer of the service needs to understand the syntax of the special file, such as the ASMX file format. In addition, to transform existing server code into exposed Web services, a developer needs to convert the existing server code into ASMX syntax. Thus, the traditional means of exposing a service for a client to use requires non trivial development effort.

While specific disadvantages of existing systems have been illustrated and described in this Background Section, those skilled in the art and others will recognize that the subject matter claimed herein is not limited to any specific implementation for solving any or all of the described disadvantages.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

Aspects of the invention supplements the traditional mechanism for exposing a service offered by a server to a client by providing a pseudo-virtual path for the service. The pseudo-virtual path allows a developer to expose a service without creating a physical file with a special extension. Such a pseudo-virtual path may also be encrypted so that information concerning the service may not be unnecessarily exposed.

According to one aspect of the invention, in a distributed computing environment including at least one server and one client, a service on the server is exposed by the server generating a pseudo-virtual path for the service. The pseudo-virtual path maps directly to the service, instead of a physical file containing the service. Preferably, an application programming user interface is provided that takes the service as a parameter and generates a pseudo-virtual path for the service.

Preferably, the pseudo-virtual path for the exposed service is integrated into a proxy class for the server. The proxy class may identify services provided by the server and information on how to call the services. The proxy class may include a description and type information of an exposed service. The proxy class may include information on how to access the exposed service, for example, by providing a pseudo-virtual path or a traditional path for the service. Once a client sends a request for the proxy class, the proxy class is sent to the client. The client can identify which service to request by examining the proxy class. The client can use the path for the service in the proxy class to request the service.

In accordance with another aspect of the invention, upon receiving a service request from a client, the server determines whether the service request includes a pseudo-virtual path. If the service request does include a pseudo-virtual path, the server provides the client the request service directly. Typically, a pseudo-virtual path includes a special token indicating that the path is a pseudo-virtual path. Content in the path following the special token is a special syntax representing the service. Therefore, when determining whether a service request includes a pseudo-virtual path, the server decides whether a path includes the special token. If a path includes the special token identifying the existence of a pseudo-virtual path, the server treats the special syntax following the special token as information representing the service. Preferably, in order to prevent unnecessary exposure of a server service, a pseudo-virtual path may be encrypted before being integrated in the proxy class. The encryption may cover only the special token, or both the special token and the special syntax.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrating exemplary interactions between a client and a server;

FIG. 2A is a block diagram illustrating an exemplary traditional path leading to an exposed server service;

FIG. 2B is an exemplary pseudo-virtual path leading to an exposed server service;

FIG. 2C is a block diagram illustrating an exemplary encrypted path leading to an exposed server service;

FIG. 3 is a flow diagram illustrating an exemplary process for exposing a server service;

FIG. 4 is a flow diagram illustrating an exemplary routine for providing a pseudo-virtual path mapping to the exposed service, suitable for use in FIG. 3;

FIG. 5 is a flow diagram illustrating an exemplary routine for determining whether a service request includes a pseudo-virtual path, suitable for use in FIG. 3; and

FIG. 6 is a block diagram illustrating an exemplary application programming interface for generating a pseudo-virtual path.

### DETAILED DESCRIPTION

The following text illustrates and describes exemplary embodiments of the invention. However, those of ordinary skilled in the art will appreciate that various changes can be made therein without departing from the spirit and scope of the invention.

Embodiments of the invention may be described in the general context of computer-executable instructions, such as program modules, being executed by a computer including at least a processor and a memory. Generally described, program modules include routines, programs, widgets, objects, components, data structures, and the like that perform particular tasks or implement particular abstract data types. Embodiments of the invention may also be practiced in a distributed computing environment where computing services are provided by some entities (“servers”) to other entities (“clients). The entities may be local to a same computing system or are linked through a communications network. In a distributed computing environment, program modules providing the services may be located on local and/or remote computer storage media.

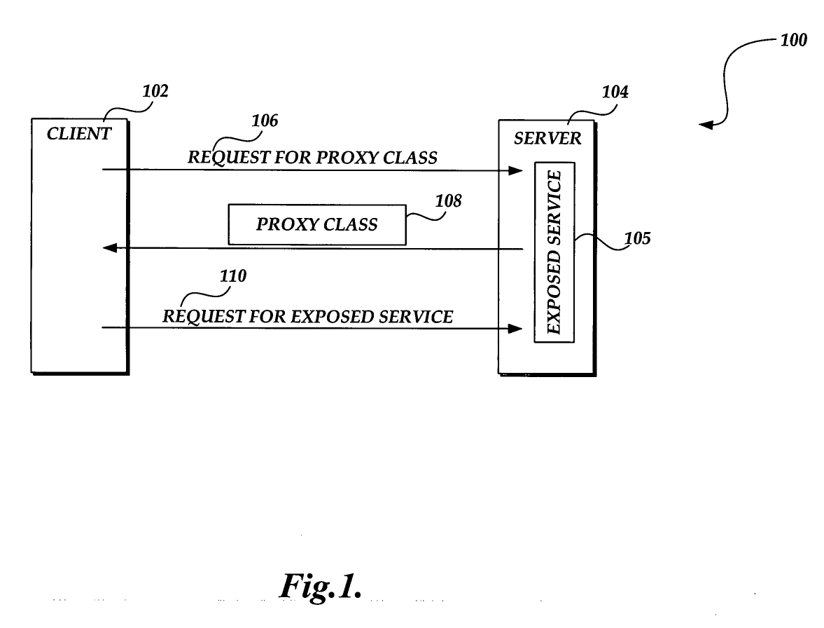

FIG. 1 illustrates an exemplary distributed computing system 100 that includes at least one client 102 and at least one server 104. The server 104 provides at least one exposed service 105 such as a Web service that the client 102 can use. A Web service generally provides one or more methods existing on the server that allow the client to call to get certain information. The following code illustrates an exemplary Web service SimpleService exposed on the server 104.

```
using System;
using System. Web.Services;
using System. Web;
using System. Web.Profile;
namespace Acme {
  public class SimpleService {
    [WebMethod]
    public string Hello World( ) {
      return “Hello from a web service that doesn′t use an asmx file”;
    }
  }
}
```

In order to expose a service 105 offered by the server 104, exemplary embodiments of the invention use a proxy class 108. The proxy class 108 may include information about what services are available for the client 102 to use. The proxy class 108 may also provide basic descriptions of the service 105 and information about how to call the service 105. Typically, the proxy class 108 provides to the client 102 representation of the service 105 offered by the server 104. The proxy class may further include information describing type information associated with the service 105. In exemplary embodiments of the invention, each exposed service 105 on the server 104 is associated with the proxy class 108.

In an exemplary embodiment of the invention, a link to the proxy class 108 for the server 104 is provided to the client 102, for example, by a developer of the client 102 who knows that the client 102 may need to use an exposed service 105 provided by the server 104. Thus, once the client 102 determines that it needs to use the service 105 described in the proxy class 108, the client 102 sends a request 106 for the proxy class to the server 104, using the link. The server 104 then returns the proxy class 108. The client 102 determines what is offered by the server 104 by examining the proxy class 108. Through the examination, the client 102 gets to know what methods it can call in order to use the exposed service 105. The client 102 then makes a request 110 for the exposed service 105 by using information provided in the proxy class 108. For example, the client 102 may call a specific method offered by the exposed service 105.

The following text illustrates an exemplary content in the proxy class 108 for the exposed service SimpleService.

```
Type. registerNamespace(‘Acme’);
Acme. SimpleService =
    { path: “/app/AtlasServices/Acme/SimpleService. asmx”,
    Hello World:function(onMethodComplete, onMethodTimeout)
    {return Atlas.Net.ServiceMethodRequest.callMethod(this.path,
    “Hello World”,{ }, onMethodComplete,
    onMethodTimeout), } }
```

In embodiments of the invention, the type information contained in the proxy class 108 for a service such as the service 105 provides an identifier for the server 104 to locate the service. The type information can be, e.g., a type name of the service, a URL leading to the service, and/or a method name of the service. For example, in the exemplary content in the proxy class 108 for the exposed service SimpleService shown above, the type information for the exposed service SimpleService includes a type name Acme.SimpleService, a URL “/app/AtlasServices/Acme/SimpleService.asmx”, and a method name “Hello World.”

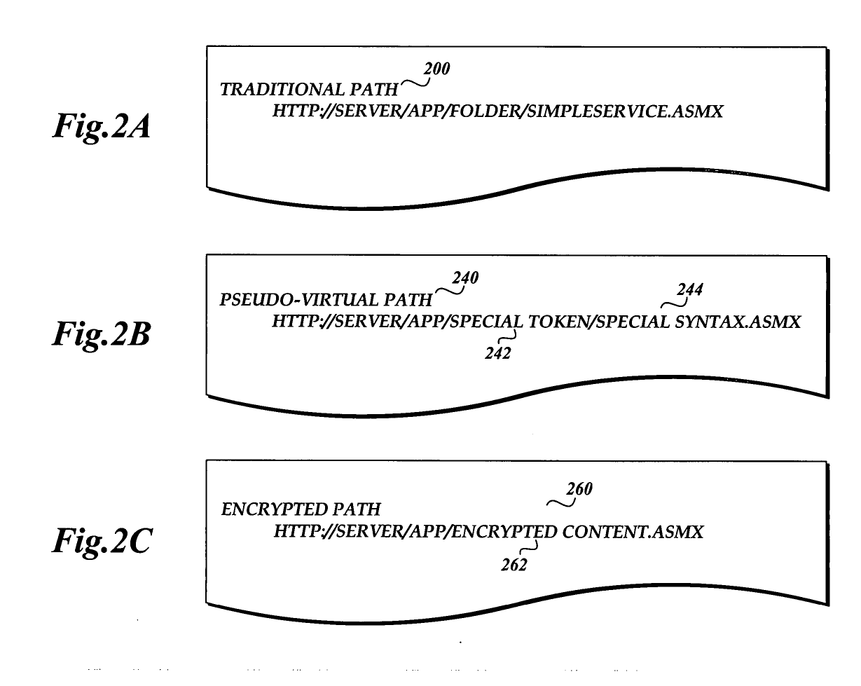

Also shown in the above exemplary content in the proxy class 108 for the exemplary SimpleService, the proxy class 108 includes a path that leads to the exposed service 105 such as the exemplary SimpleService on the server 104. In embodiments of the invention, the path leading to an exposed service 105 can be a traditional path, a pseudo-virtual path, or an encrypted path. FIGS. 2A-2C provides an example for each of the three types of path.

Typically, a traditional path leads to a physical file on the server 104 that contains the exposed service 105. FIG. 2A illustrates an exemplary traditional path 200—http://server/app/folder/SimpleService.asmx. The traditional path 200 points to a physical file—SimpleService.asmx—on the server 104.

FIG. 2B illustrates an exemplary pseudo-virtual path 240. In appearance, the pseudo-virtual path 240 looks similar to the traditional path 200. However, the pseudo-virtual path 240 does not actually map to a physical file, as the traditional path 200 does. The pseudo-virtual path 240 actually maps to the exposed service 105. As shown in FIG. 2B, the pseudo-virtual path 240 includes a special token 242 and a special syntax 244. In embodiments of the invention, the special token 242 and the special syntax 244 may be composed in any syntax or format that the server 104 can recognize. For example, in some embodiments of the invention, the special token 242 and the special syntax 244 appear as one entity, though the server 104 can recognize the special token 242 and the special syntax 244 portions in the entity. The above code for the exemplary proxy class for the exemplary exposed service SimpleService illustrates a pseudo-virtual path for the exemplary SimpleService. The path reads as “/app/AtlasServices/Acme/SimpleService.asmx”. The “AtlasServices/Acme” in the path functions as the special token 242 indicating that the path is a pseudo-virtual path. The “SimpleService.asmx” in the path is an exemplary special syntax 244 mapping to the exposed SimpleService.

In embodiments of the invention, the existence of the special token 242 in a path helps the server 104 determine that the path functions as a pseudo-virtual path 240, not as a traditional path 200 that leads to the location of a physical file. The special token 242 indicates that content following the special token 242 in the path is the special syntax 244. The special syntax 244 provides a description of what the exposed service 105 is. The special syntax 244 does not map the pseudo-virtual path 240 to a physical file on the server 104. The special syntax, though it looks much like a normal path, typically contains type information associated with the exposed service 105. For example, the type information may disclose the type name of the exposed service 105.

When shown plainly, the type information disclosed in the special syntax 244 may allow the client 102 to speculate and call service methods, to which the client 102 should have no access. For example, the client 102 may speculate that the service provided by http://Server/App/Special_Token/Forbidden.asmx could contain a method “Forbidden( )” and manufactures a method call “Forbidden( )”, wherein, in reality, the method “Forbidden( )” is provided by the service but the client 102 should have no access.

To prevent unnecessary disclosure of server information, exemplary embodiments of the invention encrypt the pseudo-virtual path 240. FIG. 2C illustrates an exemplary encrypted path 260. The encrypted path 260 may contain a traditional path 200 or a pseudo-virtual path 240. In an exemplary embodiment of the invention, the encrypted content 262 in an encrypted pseudo-virtual path contains only the special syntax 244 that maps directly to the exposed service 105. In an alternative embodiment of the invention, the encrypted content 262 in an encrypted pseudo-virtual path contains both the special token 242 and the special syntax 244.

In exemplary embodiments of the invention, no matter what type of path, e.g., a traditional path or a pseudo-virtual path, is used in the proxy class 108 to represent the exposed service 105, all that the client 102 perceives of the path is a URL for the exposed service 105. The client 102 sends the path, i.e., the URL, to the server 104 to request the exposed service 105. The server 104 interprets the received path to determine whether the received path is a traditional path 200, a pseudo-virtual path 240, or an encrypted path 260. When the server 104 detects encrypted information in the path, it first decrypts the encrypted information. The server 104 then uses the decrypted information to determine whether the path is a pseudo-virtual path or a traditional path. For example, if the server 104 detects the special token 242 in the received path, the server 104 determines that the received path is a pseudo-virtual path 240 and that the content after the special token 242 is the special syntax 244 mapping directly to the exposed service 105.

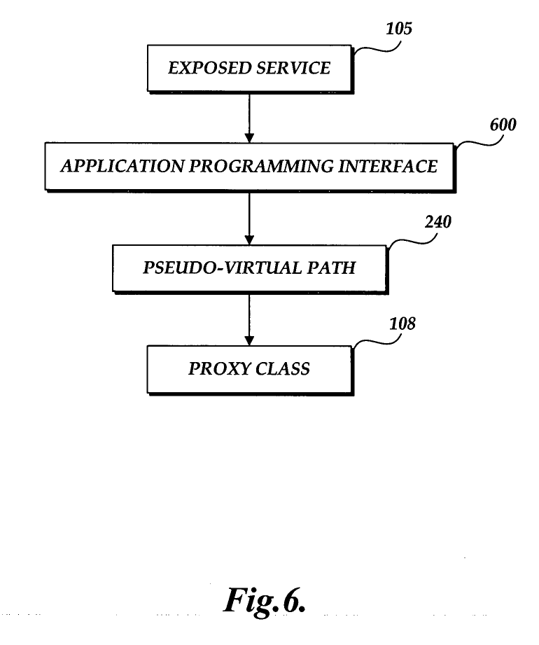

As illustrated in FIG. 6, in an exemplary embodiment of the invention, to expose a service 105 so that it can be called by the client 102, the service 105 is first registered through an application programming interface (“API”) 600. The API 600 creates the pseudo-virtual path 240 for the service 105. The pseudo-virtual path 240 then is included in the proxy class 108 for the server 104. As shown in FIG. 1, when the client 102 requests the proxy class 108, the server 104 sends the proxy class 108 containing the pseudo-virtual path 240 to the client 102. The client 102 can, thus, access the exposed service 105 using the pseudo-virtual path 240.

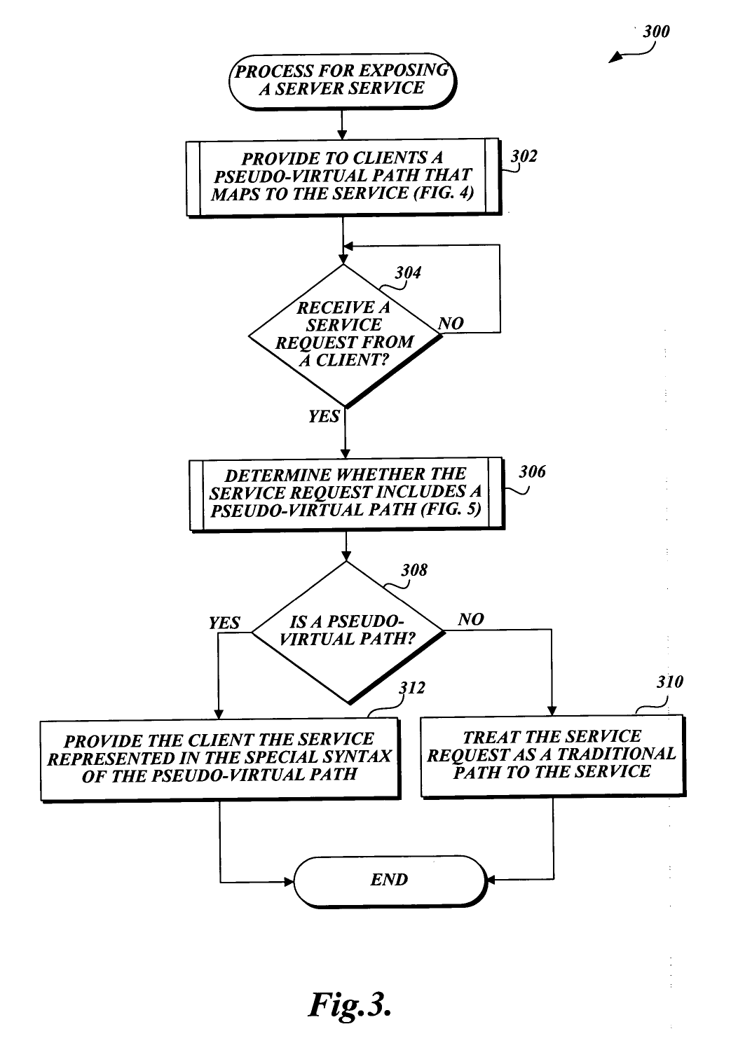

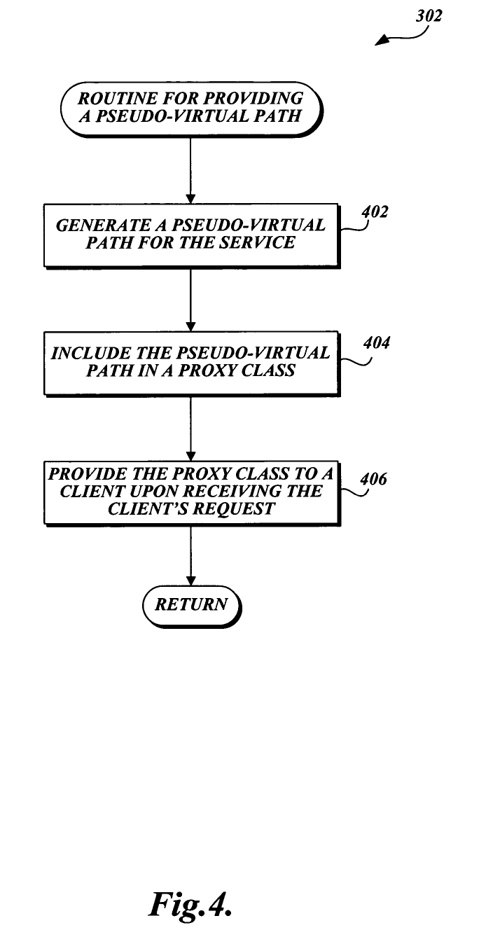

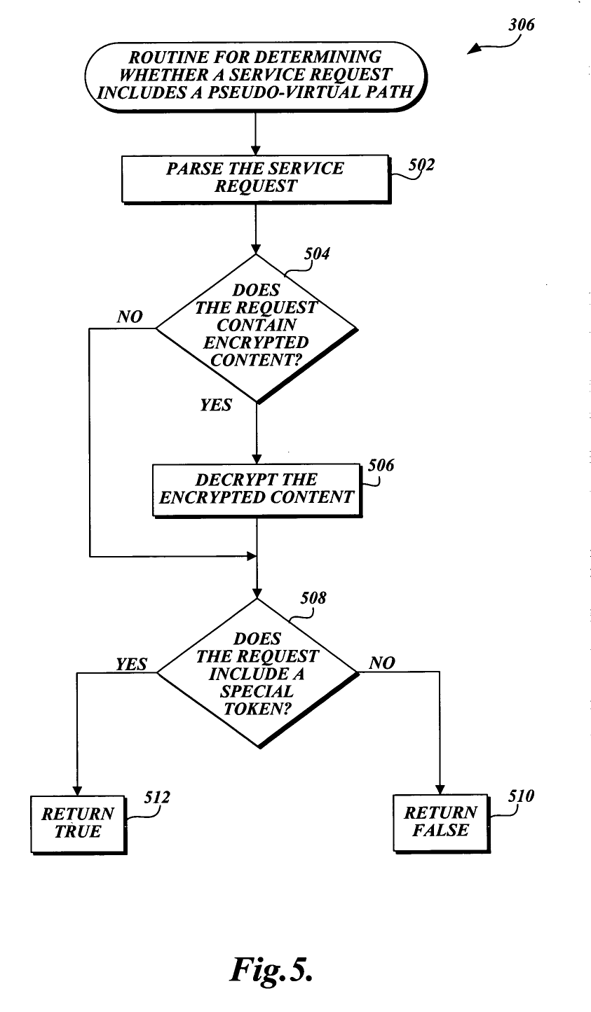

FIG. 3A illustrates an exemplary process 300 for exposing a server service using a pseudo-virtual path. Typically, the process 300 generates a pseudo-virtual path for each exposed service on a server. Upon receiving a request from a client for an exposed service, the server determines whether the request includes a pseudo-virtual path or a traditional path and supplies the exposed service accordingly. In an exemplary embodiment of the invention, as illustrated, the process 300 starts by executing a routine 302 that generates and provides to potential clients a pseudo-virtual path for an exposed service on the server. FIG. 4 illustrates an exemplary implementation of the routine 302 and will be described in detail shortly. Alternatively, a potential client for the exposed service may receive a traditional path to the service. A client that wishes to access the exposed service will send a request for the service to the server. Such a request may contain a pseudo-virtual path, a traditional path, or an encrypted path that includes either a pseudo-virtual path or a traditional path. Therefore, upon determining that the server has received a service request from a client (see decision block 304), the process 300 proceeds to execute another routine 306 that determines whether the received service request includes a pseudo-virtual path. See block 306. FIG. 5 illustrates an exemplary implementation of the routine 306 and will be described in detail shortly.

After executing the routine 306, the process 300 proceeds to determine whether the service request from the client includes a pseudo-virtual path. See decision block 308. If the answer to decision block 308 is NO, the process 300 proceeds to treat the service request as including a traditional path that maps to a physical file for the exposed service and provides the physical file to the client. See block 310. The process 300 then terminates. If the answer to decision block 308 is YES, then the service request does include a pseudo-virtual path; the process 300 proceeds to provide the client the service represented in the special syntax of the pseudo-virtual path. See block 312. The process 300 then terminates.

FIG. 4 illustrates an exemplary routine 302 for providing a pseudo-virtual path to any client intended to use the services exposed on a server. The routine 302 first generates a pseudo-virtual path for an exposed server service. See block 402. In embodiments of the invention, a pseudo-virtual path can be generated by different means. For example, as noted above, the exposed service can be passed to an API, which creates a pseudo-virtual path for the service. Alternatively, the pseudo-virtual path can be created manually or by a script.

The routine 302 then includes the pseudo-virtual path for the service in a proxy class that describes services provided by the server. See block 404. As noted above, the proxy class may also include information about what services on the server are available for a client to use. The proxy class may also include basic descriptions of a service and information about how to call a service. The proxy class may further include type information associated with a service. In an exemplary embodiment of the invention, when a client has the potential of calling a server for services offered by the server, a developer for the client embeds in the client a link to the proxy class for the server. When the client intends to use services offered by the server, the client sends a request to the server for the proxy class, using the link to the proxy class. Therefore, the routine 302 provides the proxy class to a client upon receiving a request from the client for the proxy class. See block 406. The client can then send a service request to the server, using information provided in the proxy class concerning the service. As will be appreciated by those of ordinary skill in the art, the exemplary routine 302 only provides an exemplary means of providing a pseudo-virtual path for an exposed server service. Alternative means may include, for example, using a script to generate a pseudo-virtual path for an exposed server service and supply the pseudo-virtual path upon receiving a request from a client for exposed services on a server.

FIG. 5 illustrates an exemplary routine 306 that determines whether a service request sent by a client includes a pseudo-virtual path. The routine 306 starts by parsing the service request. See block 502. The routine 306 then decides whether the service request contains any encrypted content. See decision block 504. If the service request does include encrypted content, the routine 306 proceeds to decrypt the encrypted content. See block 506. If the answer to decision block 504 is NO, meaning that the service request contains plain text, or if the routine 306 has decrypted any encrypted content, the routine 306 proceeds to determine if the service request includes a special token indicating the presence of a pseudo-virtual path. See decision block 508. If the answer to decision block 508 is YES, meaning that the service request does include a pseudo-virtual path, the routine 306 returns TRLE and terminates. See block 512. If the answer to decision block 508 is NO, meaning that the service request does not include a pseudo-virtual path, the routine 306 returns FALSE and terminates. See block 510.

In summary, embodiments of the invention provide another approach for a client to access a service exposed by a server. The pseudo-virtual path approach enables a developer to expose a server service without writing a special file with a special extension for the service. Thus, the developer can expose a server service without the need to understand the syntax of the special file or to convert existing service code into the syntax of the special file. As a result, the pseudo-virtual path approach reduces the development effort needed for exposing a server service.

Although aspects of the invention have been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The embodiments of the invention in which an exclusive property or privilege is claimed are defined as follows:

1. In a distributed computing system including a server component (“server”) (104) and a client component (“client”) (102), a computer-implemented method for exposing a service (105) provided by the server (104), comprising:
providing the client (102) a pseudo-virtual path (240) that maps directly to the service (105), instead of mapping to a physical file containing the service (105);
upon receiving a request (110) for the service (105) from the client (102), determining whether the request (110) includes the pseudo-virtual path (240); and
if the request (110) includes the pseudo-virtual path (240), providing the client (102) the service (105) according to information in the pseudo-virtual path (240).

2. The method of claim 1, wherein the pseudo-virtual path includes a special token indicating that a path is a pseudo-virtual path that maps directly to the service.

3. The method of claim 2, wherein the pseudo-virtual path also includes a special syntax representing the service.

4. The method of claim 3, wherein the special syntax provides type information of the service.

5. The method of claim 3, wherein the pseudo-virtual path is encrypted.

6. The method of claim 5, wherein only the special syntax in the pseudo-virtual path is encrypted.

7. The method of claim 5, wherein both the special token and the special syntax in the pseudo-virtual path are encrypted.

8. The method of claim 1, wherein providing the client a pseudo-virtual path includes:
generating the pseudo-virtual path;
including the pseudo-virtual path in a proxy class; and
providing the proxy class to the client upon receiving a request from the client for the proxy class.

9. The computer-implemented method of claim 8, wherein generating the pseudo-virtual path for the service includes calling an application programming interface using the service as a parameter, wherein the application programming interface generates and returns the pseudo-virtual path.

10. The computer-implemented method of claim 8, wherein the proxy class identifies at least one service exposed by the server.

11. An application programming interface embodied on one or more computer-readable media, comprising a function related to generating a pseudo-virtual path (240) for an exposed service (105) on a server (104), wherein the pseudo-virtual path (240) maps directly to the exposed service (105), rather than mapping to a physical file on the server (104) containing the service (105).

12. A computer system providing at least one service (105), comprising:
(a) memory; and
(b) a processor, coupled with the memory, that executes computer-executable instructions for:
providing (302) a pseudo-virtual path (240) that maps directly to the service (105);
upon receiving (304) a request (110) for the service from a client (102), determining (306) whether the request (110) includes the pseudo-virtual path (240); and
if the request (110) includes the pseudo-virtual path (240), providing (312) the client (102) the service (105) according to information in the pseudo-virtual path (240).

13. The computer system of claim 12, wherein the pseudo-virtual path includes a special token indicating that a path is a pseudo-virtual path that maps directly to the service.

14. The computer system of claim 13, wherein the pseudo-virtual path also includes a special syntax representing the service.

15. The computer system of claim 14, wherein the special syntax provides type information of the service.

16. The computer system of claim 14, wherein the pseudo-virtual path is encrypted.

17. The computer system of claim 16, wherein only the special syntax in the pseudo-virtual path is encrypted.

18. The computer system of claim 12, wherein the processor executes the computer-executable instructions for providing a pseudo-virtual path that maps directly to the service by:
generating the pseudo-virtual path;
including the pseudo-virtual path in a proxy class; and
providing the proxy class to the client upon receiving a request from the client for the proxy class.

19. The computer system of claim 18, wherein the processor executes the computer-executable instructions for generating the pseudo-virtual path for the service by calling an application programming interface using the service as a parameter, wherein the application programming interface generates and returns the pseudo-virtual path.

20. The computer system of claim 18, wherein the proxy class identifies at least one service exposed by the server.
